(19) United States
(12) Patent Application Publication
(10) Pub. No.: US 2025/0120878 A1
(43) Pub. Date: Apr. 17, 2025

(54) MASSAGE APPLICATOR WITH CONNECTOR CAVITY

(71) Applicant: BB3000M d.o.o., Sostanj (SI)

(72) Inventor: Bostjan BUC, Sostanj (SI)

(21) Appl. No.: 18/686,495

(22) PCT Filed: Aug. 26, 2022
(86) PCT No.: PCT/EP2022/073749

§ 371 Date: Feb. 26, 2024

(30) Foreign Application Priority Data
Aug. 27, 2021 (EP) 21193497.1

(51) Int. Cl. A61H 23/00; A61H 9/00; A61H 23/02

(52) U.S. Cl. CPC A61H 23/006; A61H 9/0057; A61H 23/0254; A61H 2201/0107; A61H 2201/0153

(57) ABSTRACT

A massage system includes a massage applicator and a massage device for reciprocatingly actuating the massage applicator in an axial direction with respect to the massage device. The massage applicator is removable from the massage device. The massage applicator includes a connector cavity. The massage device includes a connector protrusion, which is receivable in the connector cavity. The connector protrusion includes a protrusion engagement surface. The connector cavity includes a cavity engagement surface, which is formed by an inner wall of the connector cavity. The protrusion engagement surface and the cavity engagement surface are configured to engage to transmit an axial massage force from the massage device to the massage applicator. A massage applicator and a massage system including a massage device and a plurality of massage applicators are also disclosed.

### CROSS-REFERENCE TO RELATED APPLICATIONS

This patent application is the national phase of PCT/EP2022/073749 filed Aug. 26, 2022, which claims the benefit of European Patent Application No. 21193497.1, filed Aug. 27, 2021.

### TECHNICAL FIELD The present invention relates to a massage system and a massage applicator.

### BACKGROUND

In the prior art, massage systems are known in which a massage applicator is inserted in the recess of a reciprocating massage head. Unpublished international application PCT/EP2021/054891 discloses a massage device with an actuator configured to effect a reciprocating movement of a massaging head relative to a gripping section, the massaging head comprising with a negative pressure cavity. US 2016/0074641 A1 discloses a skin care device with a vibrator and a replaceable suction tip.

### SUMMARY

One object of the present invention is to provide a massage system with a removable massage applicator, enabling easily removability and mounting of the massage applicator, while enabling to transmit high massage forces.

The invention provides a massage system comprising a massage applicator and a massage device for reciprocatingly actuating the massage applicator in an axial direction with respect to the massage device. The massage applicator is removable from the massage device. The massage applicator comprises a connector cavity. The massage device comprises a connector protrusion, wherein the connector protrusion is receivable in the connector cavity. The connector protrusion comprises a protrusion engagement surface. The connector cavity comprises a cavity engagement surface, which is formed by an inner wall of the connector cavity. The protrusion engagement surface and the cavity engagement surface are configured to engage to transmit an axial massage force from the massage device to the removable massage applicator.

In particular, the massage device is adapted to reciprocatingly move the massage applicator relative to the massage device in the axial direction. In particular, the massage device is adapted, such that the connector protrusion reciprocatingly moves relative to the remaining massage device, in particular relative to a gripping section of the massage device. The gripping section may be adapted to be held by a user. The gripping section may extend inclined or perpendicular to the axial direction. The connector protrusion may extend in the axial direction.

In particular, the massage applicator is arranged at the axial front side of the massage system, while the gripping section is arranged towards the axial rear side of the massaging device.

The massage applicator may be held in a friction fit and/or form fit on the massage device. The massage applicator may be removable by hand, in particular without tools.

The connector protrusion may extend straight in the axial direction. The connector protrusion may comprise a step. The connector protrusion may have an axial rear section with a higher cross-section than an axial front section. In particular, the cross-section of the connector protrusion corresponds to the cross-section of the connector cavity. The cross-section of the connector protrusion and of the connector cavity may be non-circular. This enables that a relative rotation of the massage applicator around the axial direction may be prevented when the massage applicator is arranged with its connector cavity on the connector protrusion.

The engagement of the protrusion engagement surface with the cavity engagement surface provides for a transmission of a relatively high axial massage force with comparatively low surface pressures on the protrusion engagement surface and cavity engagement surface. Thus, despite a potential compact design of the connector protrusion and connector cavity, relatively large axial massage forces may be transmitted.

In particular, the connector protrusion and/or the connector cavity may be formed from polymer material. This enables cost efficient and beneficial manufacture. The force transmission over the protrusion engagement surface and cavity engagement surface enables a beneficial use of rather soft materials.

Preferably, the protrusion engagement surface is at least partially or fully flat. This may enable a substantially constant surface pressure over the protrusion engagement surface. Further, this may facilitate manufacture. In other embodiments, the protrusion engagement surface may have a three-dimensional shape, such as a shape with local minima and maxima, a shape with steps or a wave shape.

In particular, the protrusion engagement surface may be defined by a continuous, preferentially differentiable surface function. The shape of the protrusion engagement surface may correspond to the shape of the cavity engagement surface, such that these surfaces are in surface contact with each other. In particular, the protrusion engagement surface may provide a positive form and the cavity engagement surface may provide a corresponding negative form.

The protrusion engagement surface may be located at an axial front surface of the protrusion. The protrusion engagement surface may be provided centrally at the axial front surface of the protrusion. The protrusion has a length in the axial direction and a width and height in respective perpendicular radial directions. The protrusion engagement surface may extend over the whole width of the protrusion.

Preferably, the protrusion engagement surface is arranged normal to the axial direction. This enables that the massage force may be transmitted normal to the protrusion engagement surface, and accordingly friction forces along the protrusion engagement surface perpendicular to the normal direction thereof, may be reduced or avoided. In particular, the protrusion engagement surface extends in a plane perpendicular to the axial direction.

The connector protrusion may comprises a protrusion centering surface. The connector cavity may comprise a cavity centering surface. The protrusion centering surface and the cavity centering surface are configured to engage. This enables to maintain the orientation of the massage applicator in the axial direction. In particular, the protrusion centering surface and the cavity centering surface correspond to each other.

In particular, the protrusion centering surface may provide a positive form and the cavity centering surface may provide a corresponding negative form. The protrusion centering surface may be adjacent to the protrusion engagement surface. The cavity centering surface may be adjacent to the cavity engagement surface. The protrusion centering surface and the cavity centering surface may be at least partially arranged in an inclination to the axial direction. In particular, the protrusion centering surface and the cavity centering surface enable to transmit radial forces from the massage applicator to the connector protrusion. This enables to compensate for radial forces or torque applied to the massage applicator. In particular, the cavity centering surface may be a side wall of the connector cavity. The protrusion centering surface and the cavity centering surface may extend along the axial direction. This enables a beneficial transmission of radial forces. In other embodiments, the protrusion centering surface and the cavity centering surface may be inclined with respect to the axial direction. The connector cavity may be formed as a concave cavity. The width of the connector cavity in the axial direction may be constant or may be decline towards the axial front of the massage applicator.

A sealing element may be provided in between the protrusion centering surface and the cavity centering surface. The sealing element may be in the form of elastomeric material. The sealing element may be provided in a recess in either the protrusion centering surface or cavity centering surface. The sealing element may establish an increased friction force in between the protrusion and cavity, to enable that the massage applicator is held by means of a friction fit on the protrusion of the massage device. In particular, the sealing element may be in the form of an O-ring.

A suction opening may provided in the connector protrusion. The suction opening may be pneumatically connected to a suction pump arranged in the massage device. This enables to establish a negative pressure in the connector cavity. This may enable to firmly hold the massage applicator on the connector protrusion. In particular, the suction opening may be provided at the axial front end of the connector protrusion.

The massage applicator may have a radially outer wall portion, and the massage device may comprise a perimeter wall adapted to be arranged radially outside and around the outer wall portion of the massage applicator arranged on the connector protrusion, such that the outer wall portion is adapted to be in close alignment with a perimeter wall of the massage device. In particular, the perimeter wall establishes a recess at the axial front end of the massage device in which the massage applicator is partially arranged. The perimeter wall enables that the ingress of dust or other contaminations into the massage device may be prevented or reduced. The outer wall portion may at least partially or fully extend parallel to the perimeter wall. The radial distance in between the outer wall portion and the perimeter wall may be less than 5 millimeters, preferably less than 2 millimeters, more preferably less than 1 millimeter.

The invention further provides a massage applicator, in particular for a massage system as specified above, wherein the massage applicator is adapted to be removably mounted on a massage device and adapted to be reciprocatingly actuated by the massage applicator in an axial direction, wherein the massage applicator comprises a connector cavity. The connector cavity comprises a cavity engagement surface, wherein the cavity engagement surface is arranged inclined or normal to the axial direction.

The massage applicator may have some or all of the features as already specified above. The inclined or normal cavity engagement surface with respect to the axial direction enables the transmission of an axial massage force to the massage applicator. In particular, the cavity engagement surface is inclined in a range of at least 30 degrees, preferably 45 degrees to 90 degrees, i.e. arranged normal, relative to the axial direction.

In one embodiment, the massage applicator may comprise a negative pressure application cavity opening towards the axial front of the massage applicator. Preferably, a suction through-hole is provided in between the connector cavity and the negative pressure application cavity. This enables that the negative pressure provided by means of the suction opening in the connector protrusion is also established in the negative pressure application cavity. Thus, a massage application providing a combination of massage force and negative pressure to the massage recipient may be provided. In particular, the cross-sectional of the suction through-hole is smaller than the cross-section of the connector cavity.

The cavity engagement surface may cover at least one third, preferably, at least half or at least two third, of the area of a projection of the connector cavity in a plane normal to the axial direction. Thus, the cavity engagement surface corresponds to at least one third of the area of the cross-section of the connector cavity. Thus, comparatively large massage forces may be transmitted for comparatively low cavity sizes.

The connector cavity may be formed by a protruding cavity wall inside the massage applicator. By providing the cavity in between protruding walls, the required material for manufacturing the massage applicator may be reduced. In particular, the massage applicator may be entirely formed of walls, which substantially have the same thickness. This reduces not only the required material for forming the massage applicator, but in particular enables that the massage applicator may be formed beneficially by means of a polymer injection molding.

In one embodiment, the massage applicator has a hollow portion in between an outer wall portion, in particular the outer wall portion, which is adapted to be in close alignment with the perimeter wall of the massage device, and the connector cavity. This enables to form a lightweight massage applicator. The outer wall portion may be filled with foamed material, such as polyurethane foam. This enables increase the stability and cleanability of the massage applicator.

A massage application surface is arranged at the axial front end of the massage applicator.

The invention further provides a massage system comprising a massage device and a series of massage applicators as specified above, comprising at least two massage applicators with different massage application interfaces. The massage device is adapted for reciprocatingly actuating the massage applicator in an axial direction. Thus, a massage system is provided which can be used for various massage types, by exchanging the massage applicators.

In particular, at least one massage applicator has a massage application interface with a negative pressure application cavity, and at least one massage applicator has a massage application interface with a closed massage application surface. This enables that the massage system may be used for conventional massage, applying only massage forces, or for a cupping massage, applying negative pressure and massage force to the massage recipient at the same time.

In particular, at least two massage applicator have different massage application interfaces, wherein the different massage application interfaces of the at least two massage applicators have a different geometry.

A contact element may be provided at the axial front of the massage applicator. In particular, the contact element may be formed from a softer material than the remaining massage applicator. In particular, the contact element may form an edge portion of the negative pressure application cavity. In other embodiments, the connector element may be a flat or profiled element extending over at least half, preferably two third or the entire axial front surface of the massage applicator. The contact element may be made of silicone. In particular, the contact element may form a soft edge portion of the negative pressure application cavity. The contact element may be formed as a silicone ring.

The connector cavity or the connector protrusion may comprise a fixation protrusion, while the other one of the connector cavity or connector protrusion may comprise a fixation recess. Engagement in between the fixation protrusion and the fixation recess enables to hold the massage applicator on the connector protrusion by means of an elastic form fit. Several parallel fixation recesses may be provided on the connector protrusion and/or connector cavity in a distance to each other in the axial direction. Several parallel fixation protrusions may be provided on the connector protrusion and/or connector cavity in a distance to each other in the axial direction.

### BRIEF DESCRIPTION OF THE DRAWINGS

The invention will now be further described with respect to exemplary embodiments as shown in the following figures:

FIG. 1 shows a perspective view of the massage system according to an embodiment of the invention with the massage applicator in perspective cross-section and the massage device;

FIG. 2 shows a cross-section through the massage applicator and the front part of the massage device according to the first embodiment of the invention;

FIG. 3 shows a cross-section through a massage applicator and connector protrusion according to a further embodiment of the invention;

FIG. 4 shows a cross-section through a massage applicator and connector protrusion according to a further embodiment of the invention; and

FIG. 5 shows a cross-section through a massage applicator and connector protrusion according to a further embodiment of the invention.

### DETAILED DESCRIPTION

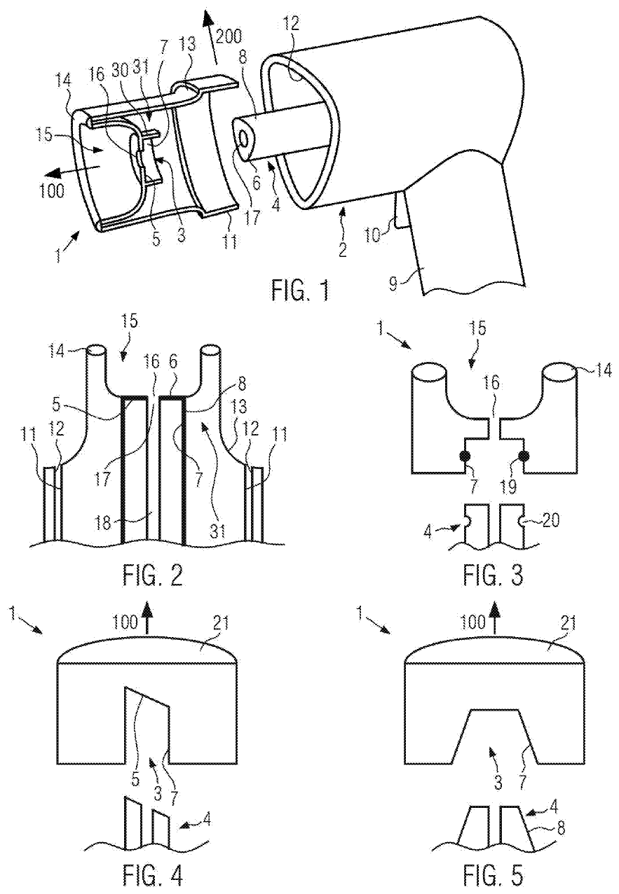

FIG. 1 shows a massage system comprising a massage applicator 1 and a massage device. The massage applicator 1 is adapted for engaging the skin of a massage recipient while being reciprocatingly actuated in the axial direction 100. The massage applicator 1 is shown in a cross-section in a plane as specified by a radial direction 200. The massage applicator comprises a connector cavity 3, which is adapted to be arranged on a connector protrusion 4 for the massage device 2.

In particular, the outer shape of the connector protrusion 4 corresponds to the inner shape of the connector cavity 3. The cross-sectional shape of the connector protrusion 4 may correspond to the cross-sectional shape of the connector cavity 3.

The inner surface of the connector cavity 3 at the axial front end of the connector cavity 3 forms the cavity engagement surface 5. The axial front end of the connector protrusion 4 forms a protrusion engagement surface 6. The cavity engagement surface 5 and protrusion engagement surface 6 are arranged normal to the axial direction 100.

As can be seen in FIG. 1, the connector protrusion 4 comprises a noncircular cross-section around axial direction 100, and the connector cavity 3 comprises an according non-circular cross-section. Thus, by arranging the connector protrusion 4 in the connector cavity 3, a form fit is established, which prevents rotation of the massage applicator 1 relative to the massage device 2 around the axial direction 100.

When the massage applicator 1 is mounted on to the massage device 2 starting from the unmounted position of the massage applicator 1 as shown in FIG. 1, the connector protrusion 4 is arranged in the connector cavity 3 and the cavity engagement surface 5 is in engagement with the protrusion engagement surface 6, as can be seen in FIG. 2.

In particular, the cavity 3 comprises a cavity side wall 30, which forms a cavity centering surface 7. The radially outer side of the connector protrusion 4 forms a protrusion centering surface 8. In the mounted state of the massage applicator 1 on the massage device 2, the cavity centering surface 7 is in surface contact with the protrusion centering surface 8, as shown in FIG. 2. Thus, the massage applicator 1 is centered on the connector protrusion 4, while the cavity engagement surface 5 and protrusion engagement surface 6 are adapted to transmit massage force in the axial direction 100. For effecting a massage, the connector protrusion 4 will be actuated to be reciprocatingly moved relative to the remaining massage device 2, in particular relative to a gripping section 9 of the massage device 2. An activation button 10 may be provided on the gripping section 9, wherein pressing the activating button 10 activates an electric motor, which preferably actuates the connector protrusion for via a crank mechanism.

The reciprocating movement of the connector protrusion with respect to the gripping section may be at least 2 millimeters, preferably 5 millimeters, and in particular more than 10 millimeters.

The massage applicator 1 further comprises an outer wall portion 11, which preferably has the largest diameter around the axial direction 100 of the massage applicator 1. The outer wall portion 11 corresponds in its radially outer form substantially to a radially inner form of a perimeter wall 12 of the massage device 2, which extends around the connector protrusion 4. As can be seen in FIG. 2, the outer wall portion 11 is arranged in close alignment with the perimeter wall 12.

In between the outer wall portion 11 and the cavity side wall 30 a hollow portion 31 is provided. The cavity side wall 30 protrudes into the hollow portion 31.

A tapered wall portion 13 may be provided in between the outer wall portion 11 and the front end of the massage applicator 1.

A soft contact element 14 for contact with the massage recipients skin may be provided at the front end portion of the massage applicator. In particular, the soft contact element 14 is a silicone ring, which surrounds a negative pressure application cavity 15 at the axial front side of the massage applicator 1.

The negative pressure application cavity 15 is connected via a suction through-hole 16 to the connector cavity 3. At the axial front end of the connector protrusion 4 a suction opening 17 is provided. The suction opening 17 is pneumatically connected via a suction channel 18 to a suction pump, arranged in the massage device 2. Thus, a negative pressure may be established in the negative pressure application cavity 15 during a massage.

In FIG. 3, a further embodiment of a massage applicator 1 according to the invention is shown. The massage applicator 1 comprises a negative pressure application cavity 15 and a connector cavity 3, which are connected via the suction through-hole 16. A contact element 14 in the form of a ring is provided. Further to the previous embodiment, the massage applicator comprises a sealing element 19, which is arranged in a groove in the cavity centering surface 7. The sealing element 19 may be in the form of an O-ring, in particular made of elastomeric material, such as rubber. The sealing element 19 enables that the negative pressure provided via the suction channel 18 establishes a negative pressure in the negative pressure application cavity 15 and reduces or prevents leakage along the protrusion centering surface 8 of the connector protrusion 4.

Independently, the sealing element 19 forms a fixation protrusion, which increases the friction in between the connector protrusion 4 and the connector cavity 3. This contributes to the friction force holding the massage applicator 1 on the connector protrusion 4.

In particular, a receiving groove 20 may be provided on the connector protrusion 4, wherein the sealing element 19 is received in the receiving groove 20, when the massage applicator 1 is in a mounted position on the massage device 2.

Independently, the receiving groove 20 forms a fixation recess, which establishes a form fit by means of engagement of the sealing element 19 in the receiving groove 20.

Furthermore, at least one engaging protrusion may be provided in the connector cavity 3, formed integrally by the material of the wall of the connector cavity 3.

FIG. 4 shows a further embodiment of a massage applicator 1 comprising a connector cavity 3 with an inclined cavity engagement surface 5. In particular, the cavity engagement surface 5 is inclined with respect to the axial direction 100. The cavity engagement surface 5 is inclined regarding the perpendicular direction of the centering surface 7. The connector protrusion 4 is accordingly inclined. This enables that by means of a form fit in between the connector protrusion 4 and the connector cavity 3, a preferred orientation of the massage applicator 1 with respect to the massage device 2 around the axial direction 100 is established.

In FIG. 5, a further embodiment of a massage applicator 1 is shown, having a connector cavity 3 with cavity centering surface 7 being inclined regarding the axial direction 100. The protrusion centering surface 8 is accordingly inclined. Thus, the insertion of the connector protrusion 4 into the connector cavity 3 is simplified, and potential tolerances may be compensated.

As can be seen in FIG. 4 and FIG. 5, a contact element 21 in the form of a concave cushion is provided at the axial front of the massage applicator 1. The concave cushion aids in the distribution of the massage force to the massage recipient's skin.

1. A massage system comprising,
a massage applicator (1), and
a massage device (2) for reciprocatingly actuating the massage applicator (1) in an axial direction (100) with respect to the massage device (2),
wherein the massage applicator (1) is removable from the massage device (2),
wherein the massage applicator (1) comprises a connector cavity (3),
wherein the massage device (2) comprises a connector protrusion (4),
wherein the connector protrusion (4) is receivable in the connector cavity (3),
wherein the connector protrusion (4) comprises a protrusion engagement surface (6),
wherein the connector cavity (3) comprises a cavity engagement surface (5), which is formed by an inner wall of the connector cavity (3), and
wherein the protrusion engagement surface (6) and the cavity engagement surface (5) are configured to engage to transmit an axial massage force from the massage device (2) to the massage applicator (1).

2. The massage system according to claim 1, wherein the protrusion engagement surface (6) is at least partially flat.

3. The massage system according to claim 1, wherein the protrusion engagement surface (6) is located at an axial front surface of the connector protrusion (4).

4. The massage system according to claim 1, wherein the protrusion engagement surface (6) is arranged normal to the axial direction (100).

5. The massage system according to claim 1, wherein the connector protrusion (4) comprises a protrusion centering surface (8), and wherein the connector cavity (3) comprises a cavity centering surface (7), wherein the protrusion centering surface (8) and the cavity centering surface (7) are configured to engage with one another such that an orientation of the massage applicator (1) in the axial direction (100) is maintained.

6. The massage system according to claim 5, wherein a sealing element (19) is provided in between the protrusion centering surface (8) and cavity centering surface (7).

7. The massage system according to claim 1, wherein a suction opening (17) is provided in the connector protrusion (4).

8. The massage system according to claim 1, wherein the massage applicator (1) has a radially outer wall portion (11), wherein the massage device (2) comprises a perimeter wall (12) adapted to be arranged radially outside the outer wall portion (11) of the massage applicator (1) when the massage applicator (1) is arranged on the connector protrusion (4), such that the outer wall portion (11) is adapted to be in close alignment with the perimeter wall (12) of the massage device (2).

9. The massage system according to claim 1, wherein the connector cavity (3) is formed by a protruding cavity wall (30) inside the massage applicator (1).

10. A massage applicator (1) configured for use as the massage applicator (1) in a massage system according to claim 1,
wherein the massage applicator (1) is adapted to be removably mounted on the massage device (2) and adapted to be reciprocatingly actuated by the massage device (2) in the axial direction (100),
wherein the massage applicator (1) comprises a connector cavity (3),
wherein the connector cavity (3) comprises a cavity engagement surface (5), wherein the cavity engagement surface (5) is arranged inclined or normal to the axial direction (100).

11. The massage applicator according to claim 10, wherein the massage applicator (1) comprises a negative pressure application cavity (15) that opens towards an axial front of the massage applicator (1).

12. The massage applicator according to claim 11, wherein a suction through-hole (16) is provided in between the connector cavity (3) and the negative pressure application cavity (15).

13. The massage applicator according to claim 10, wherein the cavity engagement surface (5) covers at least one third of an area of a projection of the connector cavity (3) in a plane normal to the axial direction (100).

14. The massage applicator according to claim 10, wherein the connector cavity (3) is formed by a protruding cavity side wall (30) inside the massage applicator (1).

15. The massage applicator according to claim 10, wherein the connector cavity (3) comprises a cavity centering surface (7) and a sealing element (19) is provided in a recess of the cavity centering surface (7).

16. The massage applicator according to claim 10, wherein massage applicator (1) has a hollow portion (31) in between an outer wall portion (11) and the connector cavity (3).

17. A massage system comprising a massage device (2) and a plurality of massage applicators (1) according to claim 10, the plurality of massage applicators comprising at least two massage applicators (1) with different massage application interfaces, respectively,
wherein the massage device (2) is adapted for reciprocatingly actuating the massage applicator (1) in an axial direction (100), and
wherein each massage applicator (1) of the plurality of massage applicators (1) has a corresponding connector cavity (3), such that the massage device (2) may receive any of the plurality of massage applicators (1).

18. The massage system according to claim 17, wherein at least one massage applicator (1) of the plurality of massage applicators has a massage application interface with a negative pressure application cavity (15), and wherein at least one other massage applicator (1) of the plurality of massage applicators has a massage application interface with a closed massage application surface.
